(19) United States
(12) Patent Application Publication
(10) Pub. No.: US 2008/0128663 A1
(43) Pub. Date: Jun. 5, 2008

(54) Positive temperature coefficient polymeric formulation

(76) Inventors: Ivanhoe Chaput, Gardena, CA (US); Steven Kidd, Fort Atkinson, WI (US)

Correspondence Address: DONALD D. MON;ATTORNEY AT LAW, SUITE 303, 750 EAST GREEN STREET, PASADENA, CA, 91101, US

(21) Appl. No.: 11/607,469

(22) Filed: Dec. 1, 2006

(51) Int. Cl. H02B 1/06

(52) U.S. Cl. 252/511

(57) ABSTRACT

A polymeric positive temperature coefficient (PTC) material useful as a component of a device for disposing electrical current into a conductive liquid while heating the liquid and regulating its temperature to a useful range, such as for a domestic hot water supply. In addition it can do so without inhibiting previously expected corrosion and build up of insoluble deposits.

### FIELD OF THE INVENTION

A polymeric positive temperature coefficient (PTC) material useful as a component of a device for disposing electrical current into a conductive liquid while heating the liquid and regulating its temperature to a useful range, such as for a domestic hot water supply. In addition it can do so without inhibiting previously expected corrosion and build up of insoluble deposits.

### BACKGROUND OF THE INVENTION

Positive temperature coefficient polymers are used for making heaters in devices such as thermal or electric blankets, for heating strips for melting snow from rooftops, and for radiant heating of floors using extruded heating strips. They are also widely used for positive temperature coefficient resettable fuses. These do not dispose electrical current into adjacent material or structures. They simply get hot.

This invention relates to a polymeric positive temperature coefficient material useful for the manufacture of non-corrosive conductive electrodes that dispose electrical current into a conductive liquid. Spaced apart electrodes of this material are immersed in the conductive liquid and an electrical current is applied to them. It is not the electrodes that generate heat, but rather the resistance of the conductive liquid between and in contact with opposed faces of the electrodes that heats the liquid by way of wattage drawn by the liquid's electrical conductivity. With this invention, positive temperature coefficient electrodes can be used to self-regulate for temperature in liquids of various conductivity.

The material sometimes referred to as a (“formulation”) can be used to make electrodes for many types of liquid heaters, for example for heating water. Useful types of water heaters include instant water heaters, tank water heaters, radiant heaters using a conductive liquid as the resistive medium, and immersion heaters. These electrodes are also suitable for electrolyzers, desalinization equipment, laboratory equipment, large electric boilers, and for any other device or machine that enables electrical current to be disposed in a conductive liquid therein.

There exist no commercially acceptable polymeric electrode liquid heaters today, and especially no polymeric electrodes made of the material of this invention. There are, however, many references in the literature to electrode water heaters that use metal or pure carbon electrodes. Challenges that early electrode heating devices faced included safety issues as well as the more electrolysis that metal electrodes exhibit when placed in the liquid, and electrical current is applied to a liquid between them.

The use of polymeric conductive electrodes has posed many unforeseen challenges that the inventors herein have solved by researching and testing hundreds of combinations of conductive packages, polymer mixes, functionalized polymers, and additives.

The deposit build-up of insoluble carbonates, especially calcium carbonate, has always been a challenging aspect of water-related heating devices, plumbing hardware and piping. Over time, these deposits can clog a system requiring it to be cleaned or replaced. It is known that electrolysis exacerbates this build-up and that polymeric conductive electrodes are not immune to them. Electrodes of any material containing certain elements are even more subject to build-up on their surface of insoluble salts extracted from the water itself, especially calcium carbonate. These depositions speedily coat the electrodes and greatly reduce their function.

Current methods of combating or slowing this process do not readily lend themselves to use with conductive polymer electrode joule heating of water. Instead the solution to this problem provided by this invention lies in providing electrode formulations that are free from ingredients that tend to seed insoluble deposits. In accordance with this invention, electrodes which are exposed to the liquid must on their surfaces be devoid of calcium, iron, sulfur, oxides, carbonates, aluminum, and any other impurity that may cause seeding of insoluble deposits, especially of calcium carbonate.

In addition, by using a functionalized polymer, the pH of the surface of the material can be changed to acidic, and therefore it is possible to push the chemical equilibrium at the exposed surface to inhibit the growth of metallic salt deposits, especially of calcium and magnesium salts and thereby promote any precipitation that might occur promptly to dissolve back into the solution.

As to the inherent regulation of the temperature of a liquid joule heated by current flowing between these electrodes, the inventors herein have found no intellectual property or even general secular information in the field of conductive polymeric electrodes for joule heating water, and especially any polymers that exhibits a useful positive temperature coefficient, hereinafter referred to as PTC. Referring to this inventor's earlier U.S. Pat. No. 6,640,048 of Oct. 8, 2003, this is believed to be the first mention of a polymeric electrode to be used for the joule heating of water.

The theoretical advantages of a PTC regulated electrode for liquid heating has led to applicant's efforts to take the art of such electrodes to a new and needed level. Studies of metal electrodes, and in particular of costly titanium electrodes have been a focus for the need for this invention, while the need for an improved version of the art which is taught in U.S. Pat. No. 6,640,048 has been another.

Presently, electrodes for joule heating liquid are most frequently made from metal, pure carbon, or titanium, which are often rhodium plated. Metal electrodes are subject to serious corrosion problems over a relatively short period of time.

In electrode boiler applications used for heating large volumes of water for industrial use or for heating a building, bulky iron rods are used as the preferred electrode material. Such large iron rods take advantage of an immense mass that has their life expectancy calculated at a predetermined rate of corrosion. In small appliances such as instant water heaters, vaporizers and tank water heaters, iron electrodes are not suitable. Should they be made of a size that would recognize cost, their life expectancy would not meet customer expectations. As a result, there has been only limited progress in the use of electrode heating of water, as also in other electrode devices such as those used in electrolyzing water and water vaporizers.

Another disadvantage of electrode joule heating liquids with metallic or carbon electrodes is the wide variation in the conductivity of the liquid to be heated, and more particularly, in domestic water produced by water treatment facilities throughout the world. In the prior art, variation in water conductivity is compensated for in a variety of methods. For large boiler applications, electric motors lift the iron rods in and out of the water, exposing more or less conductive metal surface to the water. Electronic methods have been attempted to regulate current by sine wave chopping using IGBT's, MOSFETS, Triacs and SCR's. To regulate large amounts of current that an appliance such as a typical instant water heater requires, sine wave chopping induces serious radio frequency noise that will not pass either FCC rules or European Flicker Standards, as undesirable situations.

In reference to the manufacture of conductive polymers, heretofore it has been a perceived characteristic of conductive polymeric materials that in order to achieve higher conductivity, the base polymer must be loaded with higher percentages of conductive materials known as the conductive package. A disadvantage of higher percentage conductive package loading is that it reaches a point where the polymeric compound can no longer be injection molded. This is due to the exceedingly high pressure required to fill the molds. Consequently, highly loaded conductive polymers necessitate the use of the slower and more costly process of compression molding. Another disadvantage of higher loaded polymers that are compression molded is that they exhibit low impact strength and are considered too brittle for many applications.

Regarding the use of such electrodes which themselves can regulate the temperature to which the liquid is heated, prior art conductive polymers which exhibit PTC and are used in applications such as fuses, are limited to specific temperature ranges. More particularly, specific PTC temperatures at which such a material goes from its most conductive to its least conductive state have been limited to temperatures which are much too high for use in conventional water heaters, often above the boiling point of water. As described in Chu et al. U.S. Pat. No. 5,451,919 Sep. 19, 1995, it is difficult for a polymer composition to achieve both adequate low resistivity, and high PTC effects. The present invention solves for adequate low resistivity, acceptable PTC and good coupling with the liquid all at the same time.

As a crystalline polymeric material becomes more conductive by the addition of a specific conductive package, the PTC effect is reduced in proportion. By “PTC effect” is meant the ability closely to limit the conduction of current at or above a respective “PTC” temperature. As a rule, the more conductive a PTC material becomes, the less is its bulk resistivity, and a diminished PTC spread. Conversely, when a material is made to a higher bulk resistivity, a percentage of conductive package can be devised where a maximum PTC spread anomaly is achieved. Of course there is a point where the law of diminishing returns applies.

The conductive package of the prior art has typically consisted of certain size particles of conductive material as being more beneficial to the material's conductivity than others. Early conductive polymers were loaded with metallic particles or carbon black and were suitable for use as electrostatic discharge protection containers to protect devices such as integrated circuits and computer chips. The need for more-conductive polymers introduced the now well-known types of particles such as nano-tubes, fibrils and certain carbons which as additives produce more conductive polymers than simple carbon black. These have become popular in use as part of the conductive package. The inventors have found no teachings of loading as described herein wherein loading of diminishing sizes of particles in relation to the function of filling in the voids in between larger particles is of benefit to increased conductivity.

To illustrate the mechanics of this finding, an example of greater proportion would be to start with marbles where, in between their spaces would be a filler of pea gravel with their in between interstitial spaces further filled in with sand and lastly these spaces filled in with fine powder. Of course this is an exaggerated example, but the principle of loading with particles of diminishing size can be understood from it.

According to the prior art, in order to produce a compound exhibiting a surface resistivity of <35 ohm, it was necessary for it to have a volume resistivity of <0.5 ohm-cm, requiring a higher loading of conductive additives. By utilizing the order of diminishing sizes, and in addition utilizing specially selected shapes of electrically conductive additives, the applicant has discovered that a surface resistivity of <35 ohm can be reached with a volume resistivity as high as 2.5 ohm-cm. By utilizing this feature of the invention, surface resistivity of 15 ohms, and more preferably 5 ohms have been reached with bulk resistivity of 0.5 to 1.5 ohm-cm respectively. The result is enhanced electrical coupling of the electrode to the conductive liquid while maintaining the bulk volume resistivity within a range that produces significant and most desirable PTC.

Therefore, it is another object of this invention to provide an electrode material that exhibits PTC for the purpose of joule heating a conductive liquid. Normal drinking water as supplied at any tap or faucet is a potential user of this material.

It is another object of the invention to provide a conductive package that exhibits considerably higher conductivity with considerably lower loading of the conductive package in order for the compound to be injection molded while exhibiting acceptable impact and flexural strength for many applications. This does not preclude the material from being compression molded, which would only rarely be preferred.

It is another object of the invention that the subject electrode material be useful as a component of liquid heating devices of varying types including point-of-use instant water heaters, tank water heaters, and water heaters for laboratory and medical use.

It is yet another object of the invention that the subject electrode material can also be used as a general-purpose electrode material, and more specifically as an electrode material used in devices for electrolyzing water.

It is still another object of the material of the invention that it can exhibit PTC characteristics within the conductive material to itself regulate the amount of current disposed into the water, and hence limit the water's rise in temperature by the inherent nature of the formulations described herein. The formulation of this invention is designed to reduce its bulk conductivity in relation to an increase in its temperature. The increased temperature can be the result of any or all of internal electrical resistance of the conductive polymer itself, and thermal transfer, and back heating of the electrode by the water into which it is immersed that has been joule heated by the current passed through the water.

It is a further object of the invention to provide a material for an electrode that is resistant to long or short term corrosion and contaminant deposition, especially that which is induced by electricity or electrolysis.

It is yet another object of the invention to provide a material for an electrode that does not attract deposition of insoluble salts from the liquid being heated, such as metal carbonates or sulphates, in particular calcium or iron carbonate or sulphates or other contaminants from tap water that normally deposit and build on the inside surfaces of pipes and other plumbing fittings and tubing.

It is still another object of the invention to provide a conductive package that is loaded with particles of diminishing size so as to proportionally and properly fill in voids between greater sized particles, thereby greatly increasing the material's overall conductivity while minimizing the overall percentage of loading. The result of this is a highly conductive material that is readily processed into its respective final part and which exhibits the desired PTC anomaly.

It is yet another object of the invention to provide a material that exhibits a bulk resistivity commensurate with a desired PTC effect while maintaining a sufficient degree of surface conductivity necessary for adequate coupling of electrical current into conductive liquids such as normal tap water. The unique and proper balance, termed M.SR/T.SR, (Measured Surface Resistivity divided by the Theoretical Surface Resistivity) will be fully described in the following detailed description of the invention. This balance enables the successful designing of formulations for electrodes.

It is still another object of the invention to provide a PTC material for an electrode set that can be tailored to heat a conductive liquid to a predetermined and preselected specific temperature.

### BRIEF DESCRIPTION OF THE INVENTION

In accordance with the present invention, there is provided a material consisting of a base polymer, a conductive package, and additives whereby higher surface conductivity is achieved relative to an acceptable PTC effect, the PTC temperature is an inherent function of the polymer itself, and in particular of its molecular weight, while the volume resistivity and the surface resistivity are determined by the conductive package.

According to another feature of the invention, a technique for establishing the content of a formulation with desired PTC characteristics is disclosed.

Further in accordance with this invention the properties of a polymeric electrode not subject to substantial deposition is taught.

As will become apparent, this invention incorporates two basic features. One is to provide formulations useful for electrodes which present both a suitably conductive surface and at the same time provide a temperature cut-off at temperatures which are usefully moderate, these properties being subject to selection as a function of the formulation. The other is to provide formulations for electrodes which discourage the deposition of insoluble salts on their surface from the liquid being heated.

As will be described, the considerations relative to surface conductivity and to temperature cut-off are contradictory. This invention provides guidance to provide suitable performance of both features.

The above and other features of this invention will be fully understood from the following detailed description.

### DETAILED DESCRIPTION OF THE INVENTION

This invention is a cost/performance designed material that enables the manufacture of a PTC electrode having a high surface conductivity and an acceptable PTC effect by utilizing the conductive package of the invention. This is achieved with the unique combination of conductive fillers (the conductive package) that allow for considerably lower percentage loading and as a consequence, facilitate the injection molding process, resulting in improved part strength. In addition, it provides the desirably higher surface conductivity at temperatures which are usable and tolerable at the point of use such as at a faucet for a domestic water supply.

It is to be noted that the term “electrode” of this invention is used differently from the same term where it is used in circuit protection devices. In referencing PTC composition patents as they relate to circuit protection devices, the polymeric positive temperature coefficient material is the polymeric circuit protection device itself. As such it is not an electrode in the usual sense of the word. In general, the term “electrodes” refers to a pair of metal plates or to highly conductive metal-impregnated epoxy materials onto which wires are attached. In this invention, the term “electrodes” refers to the conductive polymeric structures themselves, while their electrical connection points which are metal, are simply wire attachments to them.

As a result of empirical testing, it has been discovered that there exists no direct correlation between the bulk conductivity and the surface conductivity of different conductive polymeric compounds. Therefore the inventors have coined the term “coupling” to establish a value for the amount of electrical current disposed into a conductive liquid. The specifics of this will be described in the following description.

Prior to this invention, this value had always been empirically derived, because there was no definitive formula for the correlation between surface conductivity and coupling. The term “coupling value” as used herein is merely the current drawn for a given (assumed) surface area of electrode, the spacing apart of opposed faces, the voltage applied, and the conductivity of the liquid in between them. One versed in the art would assume that should the bulk conductivity of an electrode material increase, then the current draw should also increase. Such is not the case. Often a material of greater bulk conductivity will draw less current, given equal parameters. Hence, the term “coupling” is being used in this invention to describe that a material couples more current or it couples less current to the liquid (usually water) than a previously tested material regardless of its bulk conductivity.

Testing has also shown that characteristics of the molded surface as presented of a specific polymer and conductive package (perhaps with other additives) can affect coupling efficiency in a way that is surprisingly beneficial for the use of PTC electrodes for heating a conductive liquid. For an appreciation of this discovery, it must be remembered that when two metal electrodes are placed in water and a known voltage is applied, the conductivity of the water will draw a particular wattage. For example, it is well known that should water with a conductivity of 200 microsiemens draw 5.0 amps with a given set of metal electrodes, then when salts are dissolved therein and the water conductivity is raised to 400 microsiemens, the amperage draw will be 10 amps. Of course, this is an increase of 100% and it actually occurs.

In contrast when using the PTC polymeric materials of this invention are used, and the above exercise is repeated, the current draw will typically be raised from about 5.0 amps draw to only about 5.2 amps. This is a mere increase of 9.6%. These tests demonstrate that the coupling ratio of increasing water conductivity has been greatly enhanced in favor of the purpose and intent of the invention, namely that the conductivity of the water no longer controls the current draw. This is a counter-intuitive result and provides significant advantages in the heating of liquids, especially when the same heater might be used to heat waters of different conductivity.

It is known that the PTC effect, namely the change in resistance of the material from a more conductive to a less conductive condition (preferably nearly non-conductive) occurs when heated from a lower temperature at which the polymer is primarily in a crystalline phase to an amorphous phase. The PTC effect is most useful when it occurs within a narrow temperature range, and the change in resistance is substantial.

This is normally thought to be the point where the thermal expansion of the polymer causes the conductive particles to separate. In addition, to better understand the use of the material of this invention, the term “coupling” is used quantitatively to express how well electrical power is being transferred into a conductive liquid. An example would be to say that we are getting “good coupling”, or we are getting “poor coupling”. Coupling is determined by empirical comparison of (expected) anticipated wattage or power to be drawn for a set of conditions when water is being joule heated via conductive polymeric electrodes to the current that is actually drawn.

The term “decoupling” is used to measure a diminishing or diminished amount of power, usually measured in amps or watts, when the material exhibits PTC. As of this application, it is still not fully understood as to whether the reduction of power is solely the result of current heating of the electrodes from within, or from back-heat from the water or other liquid heating the polymeric electrodes, or from some other surface phenomenon. It is the opinion of the inventors that it is a combination of all of these and possibly of other factors also, because there appears to be an additional disconnection or decoupling effect when the apparatus is actually tested as a system when joule heating a liquid.

In support of this supposition is observation that the PTC effects are very different when a PTC polymeric material is tested in air when using a straight connection at either end of a strip of material compared to when it is tested submerged in a conductive liquid in the form of two opposed electrodes.

Basically, testing of the materials takes into consideration initial and final temperature of the material, power drawn, heat dissipation, and for electrodes in water the conductivity of the water, initial and final temperature of the water, melt temperature of the base polymer, and connection points.

It is also the findings of the inventors that coupling can be enhanced and established. Different polymers, when combined with a given conductive package will exhibit different temperatures at which the PTC effect occurs. By choosing a suitable polymer, it is possible to create a material for electrodes that will limit the temperature to which the liquid will be heated by limiting the current draw regardless of the water's conductivity. The data shown below is provided in this section as an illustration of PTC temperatures usually found in the previous art of compounds using semi-crystalline polymers. As additional examples, higher temperature crystalline polymers such as polyetheretherketone (PEEK) can be used for very high temperature limits while lower melting polymers like EVA, EEA and FRA will have much lower temperature limits.

| Polymer | Melting Point | PTC Temperature Range |
|---|---|---|
| *Polyphenylenesulfide (PPS) | 545 F. (285 C.) | 380–410 F. (193–210 C.) |
| *Polypropylene (PP) | 329 F. (165 C.) | 175–185 F. (80–85 C.) |
| *High Density Polyethylene | 275 F. (135 C.) | 158–167 F. (70–75 C.) |
| *Low Density Polyethylene | 239 F. (115 C.) | 140–149 F. (60–65 C.) |
| **Polyethylene Copolymers | 95–230 F. | 100–120 F. (30–50 C.) |
| and Terpolymers | (35–110 C.) | |

### DETAILED DESCRIPTION OF THE INVENTION

The formulation of the invention comprises a) at least one organic polymer and b) at least one conductive package. Said organic polymer comprises (a) a crystalline high density polymer, preferably a crystalline medium density polymer and most preferred a crystalline low density polymer depending on the intended PTC range and b) particles of a conductive package comprising, but not limited to graphite flake, expanded graphite, carbon black, carbon fiber, carbon fibrils and carbon nanotubes. Optionally, but preferably, one or more other additives may be employed such as stabilizers, cross linking agents, mold release agents, process aids, and antioxidants.

Examination of the pertinent properties of a hypothetical, although typical polymeric PTC material such as those used in circuit protection resettable fuses, show that the temperatures required to produce the PTC effect are far above the boiling temperature of water and therefore are not acceptable for joule-heating liquids such as water. Also, the PTC materials of the prior art exhibit inadequate coupling to a conductive liquid. The reasons for this have been discovered through empirical testing during the inventors' search for a material that would perform as needed. It was discovered that these materials have a very high surface resistivity (defined below) and therefore simply will not work for the purposes of this invention.

In contrast, comparing the temperature of various resistances of an exemplifying formula of this invention shows that it will heat a conductive liquid to no higher than about 185 F (85 C). Such a formula may comprise a polypropylene polymer with a specifically designed conductive additive package yielding a volume resistivity of >0.5 ohm-cm and <5 ohm-cm, and more preferably 0.7-1.5 ohm-cm.

By a variation of this example, when the volume resistivity is <0.5 ohm-cm, the PTC effect is minimized to a point where the electrode will still couple to the conductive liquid and maintain heating of the liquid, but at a greatly reduced efficiency. By further variation of the example, when the volume resistivity of the compound is >5 ohm-cm, the electrode may not couple efficiently to said liquid, and in some cases, may not couple to any liquid at all should the resistivity become too high.

When metal is used as the material of a set of electrodes to heat water and the conductivity if the water increases, the electrical current drawn increases in direct proportions. As an example, an increase of 100 microsiemens could yield an increase of 10 amps. Each subsequent increase or 100 microsiemens therefore adds an additional 10 amps. This is a straight-line relationship. However, electrodes which are made of the material of this invention, have a significant PTC property and act contrary to the above example. They exhibit a pronounced incremental decrease in amperage drawn with increased water conductivity. This is mostly due to the increase in temperature of the water spurring the PTC effect. Interestingly, tests performed at a particular temperature and increasing water conductivity showed only a slight increase in amperage draw. This was a surprising result and very important to this invention.

Control of volume resistivity of the polymer is critical to maintain a usable PTC effect. The importance of an optimized conductive package of the invention will become apparent when viewed in light of the ratio M.SR/M.SR [Measured Surface Resistivity (M.SR) divided by the Theoretical Surface Resistivity T.SR)].

A dichotomy exists in the relationship of volume resistivity and surface conductivity. Prior art has universally misunderstood volume conductivity to have parity with surface conductivity. This is emphatically not the actual situation.

Placing a mathematical value on the ratio of M.SR/M.SR shows that a tremendous disparity does in fact exist. The challenge is to provide a material with sufficient volume resistivity to allow for adequate PTC effect, while also providing for adequate surface conductivity to impart coupling of electrical current into a conductive liquid. This obviously compares a volume-related value to a surface-related value. Such a comparison would seem to be on its face illogical. However it has proved to be the means to devise the preferred product of this invention.

Prior conductive formulations that exhibited substantial PTC have possessed high surface resistivity, and consequently a surface conductivity that was too low to couple adequate electrical energy to a conductive liquid in order for it to heat the water. Conversely, prior conductive formulations with adequate surface conductivity to couple sufficient amounts of electrical energy into a conductive liquid possessed very high loading of the conductive package with low volume resistivity. As a consequence of low volume resistivity, no or very little PTC effect was experienced. Accordingly neither of these would function for the purposes of this invention.

This invention's use of an optimized conductive package that will yield a low M.SR/T.SR ratio number provides the desired advantages of a high PTC effect while maintaining low surface resistivity, thereby providing efficient coupling to heat a liquid with a substantial amount of power per area of electrode surface.

Because it is not specifically limited to use with tap water as supplied by any contemporary water infrastructure, the present invention is generally described with reference to any conductive liquid. The criteria for an optimum PTC composition for coupling electrical energy into water are given as examples, which are, a) a surface resistivity of less than 15 ohms, preferably 10 ohms and most preferably 5 ohms, b) a volume resistivity of less than 0.5 ohm-cm, preferably 1.5 ohm-cm and most preferably 2.5 ohm-cm, c) a PTC threshold in the upper ranges of, but not limited to 190° F., preferably 140° F., and most preferably 120° F., d) the capacity to withstand a voltage of 110 to 240 VAC, e) a PTC anomaly of 12 times its initial ohmic resistance, preferably 32 times and most preferably 48 times, and f) the ability to withstand long-term immersion in a liquid such as water.

Herein, the term “volume resistivity” is used according to ASTM D-257 using 10 volts as the test voltage and units as ohm-cm. The term “surface resistivity” is used according to the test jig described in MIL-P-82646-B using 10 volts as the test voltage and units in ohms. The term “PTC” refers to an increase in electrical resistance due to temperature increase. The terms “coupling” or “electrical coupling” refer to the ability or efficiency of a conductive electrode pair (set) to transfer electrical power into a conductive liquid when immersed in the liquid. The term “optimized” or variations thereof refers to a conductive package that has been selected to produce optimum “electrical coupling” between the face of a body of the formulation and the conductive liquid it is immersed therein. In the context of this invention Tₛ is used to denote the “switching” temperature at which the “PTC” effect (an increase in resistivity) takes place whereas Tₘ is used to denote the polymer's melting point.

The organic crystalline polymer component of the composition of the present invention is generally selected from, but is not limited to, a crystalline polymer such as one or more olefins and in particular polyethylene, low density polyethylene, medium density polyethylene, high density polyethylene, polypropylenes, and polyethylene copolymers and terpolymers, including higher temperature crystalline polymers such as polyamide, thermoplastic polyester, polyphenylene sulfide, polyetheretherketone or any other crystalline polymer. All of these are preferred embodiments.

A conductive package is generally selected from, but not limited to carbon black, purified carbon black, natural graphite, synthetic graphite, purified graphite, expandable graphite, expanded graphite, carbon fibers, carbon fibrils, graphite flake and graphite fibers.

It is understood that the Tₛ (switching point, or point of greatest PTC effect) of a PTC polymer compound is generally slightly below the Tₘ (its melting point).

The preferred polymer component of the present invention has a crystallinity of at least 10% and preferably between the range of 40% and 98%. To achieve the desired low Tₛ temperatures of the purpose of the invention, it is preferable that the polymer has a melting point (Tₘ) in the temperature range of 100° F. to 330° F. But higher melting temperature polymers can be used for even higher Tₛ. The crystalline or semi-crystalline polymers of the invention may comprise, but are not limited to polypropylene with a melt temperature of 325-330° F. A high density polyethylene with a melt temperature of 225-270° F., low density polyethylene

With a melt temperature of 230-250° F., and polyethylene copolymers and terpolymers having melt temperatures of 100-225° F. For higher Tₛ temperatures, crystalline polymers such as polyamide, thermoplastic polyester, polyprolyplene sulfide, polyetheretherketone or any other high temperature crystalline thermoplastic may be used. These values depend heavily on the molecular weight of the polymer, which can be selected for appropriate temperature.

Polypropylene and polyethylene of low to high density can exhibit acceptable PTC effect when the volume resistivity of the compound is 2-100 ohm-cm and very little PTC effect when the volume resistivity is less than 0.5 ohm-cm. Polyethylene copolymers and terpolymers can exhibit a wide range of Tₘ temperatures, and consequently the invention makes use of their low Tₘ. These can be used advantageously in lower temperature applications, such as domestic water heaters.

The polymers used can be, but do not need to be a functionalized material. However, the benefit of functionalization can be to help minimize contamination of the surfaces of the electrodes. Polymers are functionalized to modify the pH on the exposed surface of the electrode in order to force acidity within the polymer which causes any salt deposits on the surface of the electrodes from the conductive liquid to dissolve back into the liquid.

All of the materials, conductive particles, polymers, mold release agents, cross linking agents, additives and so forth of the invention should be of high purity, to attain best long-term utility, namely the avoidance or minimizing deposits of insoluble salts on the surface of the electrode. For this purpose, specification of low metallic ion content of all materials is necessary to eliminate seeding especially of calcium growth, and iron deposits from impurities which are inherent in most water supplies.

Contaminants in the formulations when used for electrodes must be excluded to a maximum extent. By non-limiting examples, calcium, iron, sulfur, aluminum, magnesium, their oxides and carbonates, and silica should be avoided. These can be grouped under the heading of “low ionic contamination”. The total collective quantity of them should be limited to 1,000 PPM, more preferably to 500 PPM and most preferably to less than 100 PPM. For any of the component materials supplied including conductive materials, polymers and additives, it is possible to obtain most of these individual materials with less than 50 PPM ionic contamination. As an example, specification of thermally purified graphite is common.

By way of non-limiting example, the electrically conductive fillers comprising one conductive package includes (1) sizes of graphite flake of a first order size ranging from about 100 microns to preferably 50 microns and a second order size ranging from 49 microns to preferably 25 microns and a third order size ranging from 24 microns to preferably less than 5 microns, and (2) a first order size of expanded graphite of a size ranging from about 300 microns to preferably 125 microns, a second order of size ranging from 124 microns to preferably 45 microns, a third order of size ranging from 44 microns to preferably 25 microns and a fourth order size ranging from 24 microns to preferably less than 5 microns. In addition, it is preferable also to include carbon black, purified carbon black and carbon fiber for optimization of the conductive package. Typically, carbon black ranges in size from 10-100 nm and carbon fiber typically 7-10 micron in diameter.

For best advantages the conductive package must be optimized. Optimization means blending a conductive package into the polymer such that after electrodes have been produced using the formulation of the invention, an optimized electrical coupling to the respective conductive liquid has been achieved. Optimization is the result of utilizing a variety of electrically conductive additives including, but not limited to carbon black, purified carbon black, natural graphite, synthetic graphite, purified graphite, expandable graphite, graphite flake, expanded graphite, carbon fibers, carbon fibrils and graphite fibers. The purpose of this package is to enhance the surface conductivity, which is necessary to enhance the electrical coupling to the conductive liquid, while maintaining a relatively low volume or bulk conductivity, or high volume resistivity at approximately 0.4 to 2.0 ohm-cm.

The chart below illustrates that the addition of any one electrically conductive additive will result in improved electrical conductivity, but the electrode will not be optimized for coupling to the conductive liquid. Examples of 50% loading of single various electrically conductive additives in polypropylene are discussed below. For these examples, the volume resistivity was measured using ASTM D-257 with a test voltage of 10V. The surface resistivity was measured by using the test method per MIL P-82646-B, with the exception that 10V was used as the test voltage rather than the stated 500V. M.SR/T.SR means the Measured Surface Resistivity divided by the Theoretical Surface Resistivity. The M.SR/T.SR ratio indicates a conductive polymer's ability to couple to water. The objective is to compound a material with sufficient PTC and the lowest possible M.SR/T.SR number. The term T.SR is arrived at by dividing volume resistivity by the specimen thickness.

| | Conductive | Volume Resistivity | Surface Resistivity | |
|---|---|---|---|---|
| | Additive | in ohm-cm | in ohms | M.SR/T.SR |
| Example 1 | Carbon fiber | 0.2 ohm-cm | 68 ohms | 102 |
| Example 2 | 50 micron graphite flake | 20 ohm-cm | 750 ohms | 11.2 |
| Example 3 | 25 micron graphite flake | 6 ohm-cm | 180 ohms | 9 |
| Example 4 | 5 micron graphite flake | 2.5 ohm-cm | 70 ohms | 8.4 |
| Example 5 | 125 micron expanded graphite | 2.8 ohm-cm | 60 ohms | 6.45 |
| Example 6 | 45 micron expanded graphite | 2.3 ohm-cm | 48 ohms | 6.25 |
| Example 7 | 25 micron expanded graphite | 1.9 ohm-cm | 40 ohms | 6.3 |
| Example 8 | 5 micron expanded graphite | 1.5 ohm-cm | 30 ohms | 6 |
| Example 9 | *Conductive carbon black | 2 ohm-cm | 40 ohms | 5.9 |
| Example 10 | *purified carbon black | 2 ohm-cm | 40 ohms | 5.9 |

The test specimens were 3 mm thick for surface resistivity measurements.

This data shows that an increased aspect ratio (length of fiber or diameter of flake divided by the fiber diameter or flake thickness) improves the efficiency of a conductive additive to achieve lower volume resistivity, but does not necessarily result in lower surface resistivity. It also shows that smaller conductive additives are more efficient and do result in lower surface resistivity. It should also be observed that carbon black has a 3-dimensional structure and can not be given an aspect ratio, but rather is given a structural rating. Highly structured carbon blacks are more efficient than less structured carbon blacks. However, the latter also makes the processing of the compound more difficult.

In contrast to the above data, the present invention utilizes more than one conductive additive to achieve lower volume resistivity with less conductive additives to lower the M.SR/T.SR ratio. By using more than one particle size, it is possible to improve on the electrical properties of the compound and create a more efficient electrode that will couple best to a conductive liquid through the process of optimization. The following data shows these results.

| | Conductive | Volume Resistivity | Surface Resistivity | |
|---|---|---|---|---|
| | Additive | in ohm-cm | in ohms | M.SR/T.SR |
| Example 11 | *40% Carbon black | 0.33 ohm-cm | 8 ohms | 7.3 |
| | and 10% carbon fiber | | | |
| Example 12 | 5 micron graphite flakes | 1.8 ohm-cm | 48 ohms | 8 |
| | and 45 micron graphite flakes | | | |
| Example 13 | 5 micron expanded graphite | 1.1 ohm-cm | 22 ohms | 6 |
| | and 45 micron expanded graphite | | | |

The above data shows that an optimized conductive package requires multiple sizes and shapes of conductive additives to better lower the M.SR/T.SR value. This allows the compound to provide a sufficient volume resistivity to cause the PTC effect to work while also providing for adequate coupling of the electrode to a conductive liquid.

Further optimization can be achieved by utilizing unique particle shapes of the various conductive additives. As non-limiting examples, carbon black has a dendritic structure while graphite flake has a fragile, coarse flake-like structure with limited aspect ratio. Expanded graphite has a very thin, plate-like, flexible structure with high aspect ratio, while fibers also have very high aspect ratios. By virtually unlimited combination, mixing the conductive particle shapes together, similar to fitting puzzle pieces together, is the means by which the highest degree of optimization of the conductive package can be achieved.

As will next be seen, the M.SR/T.SR data for the material of the invention indicates that although carbon fiber can lower volume resistivity, it does not contribute appreciably to the lowering of surface resistivity. In addition, expanded graphite is shown to be more efficient than graphite flake, and that the consequence and object of the invention for loading of diminishing size particles produces the most optimized conductive package with the lowest possible M.SR/T.SR value. The result of which is a material that is easy to produce by various molding processes, including injection molding and exhibits significant PTC effect while also exhibiting excellent coupling to the conductive liquid.

| | Conductive | Volume Resistivity | Surface Resistivity | |
|---|---|---|---|---|
| | Additive | in ohm-cm | in ohms | M.SR/T.SR |
| Example 12 | 20% Carbon black, | 0.8 ohm-cm | 16 ohms | 6 |
| | and 20% 25 micron fiber flake, | | | |
| | and 10% carbon fiber | | | |
| Example 13 | 20% Carbon black, | 0.5 ohm-cm | 9.3 ohms | 5.6 |
| | and 20% mixed size from | | | |
| | 5 micron to 125 micron graphite | | | |
| | flake, and 10% carbon fiber | | | |
| Example 14 | 20% Carbon black, | 0.8 ohm-cm | 14 ohms | 5.2 |
| | and 15% 25 micron graphite | | | |
| | flake, and 15% 25 micron | | | |
| | expanded graphite | | | |
| Example 15 | 20% Carbon black, | 0.5 ohm-cm | 8 ohms | 4.8 |
| | and 15% mixed sizes from | | | |
| | 5 micron to 125 micron graphite | | | |
| | flake, and 15% mixed sizes from | | | |
| | 5 micron to 125 micron | | | |
| | expanded graphite | | | |
| Example 16 | 25% Carbon black, | 0.5 ohm-cm | 5.8 ohms | 3.5 |
| | and 25% mixed size from | | | |
| | 5 micron to 125 micron | | | |
| | expanded graphite | | | |
| Example 17 | 22.5% Carbon black, | 1.1 ohm-cm | 14 ohms | 3.8 |
| | and 22.5% mixed size from | | | |
| | 5 micron to 125 micron | | | |
| | expanded graphite | | | |
| Example 18 | 20% Carbon black, | 3.3 ohm-cm | 40 ohms | 3.6 |
| | and 20% mixed size from | | | |
| | 5 micron to 125 micron | | | |
| | expanded graphite | | | |

As to temperature vs resistance of the material Example 16, 21 above shows a PTC increase in resistance of 5 times at 50 C. (122 degrees F.). However the PTC regulation starts at 32 C (89.6 F). 23 The temperature vs. resistance example of Example 17 above 24 shows a PTC increase in resistance of 8 times at 50 C (122 F), whereas the PTC regulation starts at 40 C (104 F).

Example 18 shows a radically increased resistance of 23 times at 50 C (122 F) while the PTC regulation starts at 48 C (118.4 F).

These examples are illustrative of the versatility of the invention to tailor resistance and temperature regulation through optimization of the conductive package in order to achieve the lowest possible M.SR/T.SR.

The various carbon additives are physically blended with the polymer or polymer blend and then compounded in a melt extruder. The extruder can be of any type such as a single screw, twin screw co-rotating, twin screw counter-rotating, or kneader type of extruder so as to provide a homogeneous mixture after compounding. The extrudate is granulated into pellets, typically, but not necessarily approximating ⅛ inch (3 mm) so as to make them usable for injection or compression molding or extrusion processes. The subsequent pellets are then dried.

The compounded and dried material is then molded or extruded into the form of the desired electrode. The molding can be done either by injection or compression molding. Extrusions can be used to create certain configurations desirable for electrodes such as, but not limited to, an extruded sheet that can be die cut to the desired size of electrode. The material can also be co-extruded into tubing whereby one electrode is disposed inside another electrode separated by a co-extrusion of compatible insulating polymer.

The formulation of the invention, when formed into an electrode for joule-heating a conductive liquid will act as both a current and temperature-limiting device. By controlling selection of the polymers used and their electrical conductivity by means of the conductive package, formulation can be manufactured that can limit temperature and current draw regardless of coupling into any conductive liquid material and still provide a useful PTC effect.

It is an unfortunate property of plastic electrodes that they generally become coated with insoluble salts rather quickly, which greatly reduces their efficiency. The inventors have determined that the inclusion in the plastic material and in the materials of the conductive packages of certain metals and metallic compounds is the cause.

It has been found that contaminate free polymeric material can be made, although prior to their work, they found no available product and proceeded to have the material manufactured on a custom basis. So prepared, it did function well, and did not gather deposits.

The same effort was made with material of the conductive package, although the inventors were able to obtain carbon additives that were free of the undesired impurities.

When these unusual ingredients were combined, and all other additives were also freed of the undesired elements, the electrodes functioned as anticipated, and did not gather deposits of insoluble salts.

This feature, independent of a conductive package, is useful for electrodes which do not exhibit PTC.

The ratio M.SR/T.SR is an unusual relationship which ordinarily would not be thought of. Its units are inconsistent and relate to measured and anticipated values. It is surprising in its own right that it enables a person devising a PTC electrode how to proportion selected ingredients for a conductive package for a specific plastic to achieve an electrode which will function in a liquid environment. The objective is to obtain a mixture with a ratio number as low as possible. This is a powerful and surprising enabling process and greatly reduces the trial and error of making a large number of formulations hoping to find a useful one.

This invention is not to be limited by the embodiments described in the description, which are given by way of example and not of limitation, but only in accordance with the scope of the appended claims.

We claim:

1. A formulation for an electrically conductive electrode for submersion in an electrically conductive liquid, said electrode comprising a body of said formulation having a bounding surface intended for contact with the liquid and with a source of electricity connected to said body, said formulation comprising:
an organic polymer together with a conductive package intimately mixed therein, said formulation exhibiting PTC characteristics including a reduction in conductivity at a conversion temperature, said conductive package comprising particles of carbonaceous material to provide enhanced conductivity to the formulation as a function of the structure and shape of the particles and their conductivity, resulting in a body having a bulk conductivity, and on its surface the property of coupling connectivity with the said liquid, said bulk conductivity and surface coupling connectivity being jointly selectable as a function of the identity of the polymer and of the identity, size and concentration of the particles comprising the conductive package, whereby to establish the bulk resistivity and the surface coupling conductivity of the formulation, the PTC temperature being an inherent property of the formulation.

2. A formulation according to claim 1 in which the polymer is selected to establish a PTC temperature of the formulation below the boiling point of water.

3. A formulation according to claim 1 in which the selection of the ingredients of the conductive package, and their respective amounts in the polymer are directed by the reduction of the numerical ratio M.SR/T.SR.

4. A formulation according to claim 3 in which the said ratio is less than about 8.0.

5. A formulation according to claim 1 in which said conductive package includes particles of diminishing sizes.

6. A formulation according to claim 5 in which said particle sizes are selected to enable smaller sizes to fit into interstices between larger particles.

7. A formulation according to claim 1 in which the surface configuration of at least some of the particles is irregular.

8. A formulation according to claim 1 in which at least some of said particles are flakes, fibers, fibrils, nanotubes or combinations of any of them.

9. A formulation according to claim 1 in which said formulation is substantially devoid of elements which react with ions in the liquid which would form an insoluble salt on the surface of the formulation.

10. A formulation according to claim 9 in which said elements comprises one or more of calcium, iron, sulfur, aluminum, magnesium, silicon, and their oxides and carbonates

11. A formulation according to claim 2 in which the selection of the ingredients of the conductive package, and their respective amounts in the polymer are directed by the reduction of the numerical ratio M.SR/T.SR.

12. A formulation according to claim 11 in which the said ratio is less than about 8.0.

13. A formulation according to claim 11 in which said conductive package includes particles of diminishing sizes.

14. A formulation according to claim 11 in which said formulation is substantially devoid of elements which react with ions in the liquid which would form an insoluble salt on the surface of the formulation.

15. A formulation according to claim 1 in which the polymer is functionalized to modify the pH at the bounding surface of a body of such formulation to inhibit deposition of insoluble salts thereon.

16. A method for deriving a formulation according to claim 1 in which test specimens of formulations with different polymers and different conductive packages are measured and calculated for their M.SR/T.SR, and formulations are then prepared from data derived from these tests for the purpose of minimizing the numerical ratio of M.SR/T.SR, whereby to identify a formulation with resistivity and bulk conductivity having a defined PTC conversion temperature relative to its surface conductivity.

17. A formulation for an electrically conductive electrode for submersion in an electrically conductive liquid said electrode comprising a body of said formulation having a bounding surface intended for contact with the liquid and with a source of electricity connected to said body, said formulation comprising:
an organic polymer together with a conductive package intimately mixed therein, said formulation comprising particles of carbonaceous material to provide enhanced conductivity to the formulation as a function of the structure and shape of the particles and their conductivity, resulting in a body having a bulk conductivity, and on its surface the property of coupling connectivity with the said liquid, said bulk conductivity and surface coupling connectivity being jointly selectable as a function of the identity of the polymer and of the identity, size and concentration of the particles comprising the conductive package, whereby to establish the bulk resistivity and the surface coupling conductivity of the formulation.
